(19) United States
(12) Patent Application Publication
(10) Pub. No.: US 2022/0384925 A1
(43) Pub. Date: Dec. 1, 2022

(54) METHOD FOR PRODUCING A BATTERY CELL

(71) Applicant: VOLKSWAGEN AKTIENGESELLSCHAFT, Wolfsburg (DE)

(72) Inventors: Alexander BREUER, Celle (DE); Talia BATRES HERMOSILLO, Braunschweig (DE); Dennis BÖHM, Wolfenbüttel (DE)

(73) Assignee: VOLKSWAGEN AKTIENGESELLSCHAFT, Wolfsburg (DE)

(21) Appl. No.: 17/827,017

(22) Filed: May 27, 2022

(30) Foreign Application Priority Data
May 31, 2021 (DE) 10 2021 114 006.4

(51) Int. Cl. H01M 50/636; H01M 10/058; B23K 26/20; B23K 26/12

(52) U.S. Cl. CPC H01M 50/636; H01M 10/058; B23K 26/206; B23K 26/1224; H01M 2220/20

(57) ABSTRACT

A method for producing a battery cell involves producing a battery cell with a housing having a first volume containing a multiplicity of electrodes are stacked one on top of another and an electrolyte, wherein the electrolyte can be introduced into the first volume via an opening in the housing.

### CROSS REFERENCE TO RELATED APPLICATIONS

This application claims priority from German Patent Application No. 10 2021 114 006.4, filed May 31, 2021, which is incorporated by reference in its entirety.

### FIELD OF THE INVENTION

The invention relates to a method for producing a battery cell, in particular a lithium-ion battery cell. The battery cell has a housing having a first volume and, in the first volume, a multiplicity of electrodes stacked on top of one another and possibly additionally wound (e.g. jelly roll) and an electrolyte.

The invention is used in particular in the production of lithium-ion batteries, for example for electrified vehicles.

### BACKGROUND OF THE INVENTION

A battery cell is a power storage device that is used, for example, in a motor vehicle for storing electrical energy. In a battery cell, electrode foils, i.e. anodes and cathodes, are arranged stacked on top of one another, wherein different electrode foils are arranged separated from one another by separator foils or a separator material. These electrode foils and the separators are referred to below as electrodes. The electrodes are arranged in an electrolyte within a housing.

The electrode foils arranged inside the housing are connected to an electrical circuit outside the housing via so-called conductors. The conductors extend outwards through the gas-tight housing and form an electrical connection on an outer peripheral surface of the housing. Inside the housing, the conductors are connected to the large number of electrode foils of the same type, i.e. anodes or cathodes in an electrically conductive manner. In this case, a conductor is connected in particular to a multiplicity of electrode foils.

In a current design of a battery cell, a stack of electrodes, which are only stacked or additionally wound, are arranged within a dimensionally stable housing. Such a dimensionally stable, i.e. in particular only plastically deformable housing is also referred to as a prismatic battery cell. The dimensionally stable housing has in particular a cover on which at least one electrical connection for the electrical connection of the electrodes arranged inside the housing to a circuit arranged outside the housing and a (closable) opening for filling with the electrolyte is provided.

To produce a battery cell, the housing is provided, the electrodes are arranged in it and the housing is filled with an electrolyte. After filling the electrolyte and degassing the volume of the housing, the filling hole for the electrolyte is closed. Currently, this sealing is performed with known laser or ultrasonic welding. However, the implementation of this process with optimal quality is currently still an open challenge. Especially with conventional laser welding of aluminum or aluminum alloys, only porous weld seams can regularly be achieved. This creates sparks and material spatter during the welding process. Metallic particles are produced when ultrasonic welding is carried out as an alternative. The spatters of aluminum or other metallic materials during the welding process or the particles generated during ultrasonic welding not only cause contamination on the housing, but can also lead to contamination of the electrolyte, resulting in poor battery cell performance. For these reasons, it is desirable to seal the electrolyte fill hole in a manner that protects both the electrolyte and the battery cell components arranged within the volume.

There is therefore a need to provide a method for producing such welded joints that is suitable for mass production, in particular a method that can be carried out with currently available laser devices.

A method for the production of a battery cell is known from US Patent Application Publication No. 2012/0070722 A1. In this case, a filling opening of the battery cell for an electrolyte is closed by a laser welding process. For this purpose, the battery cell is arranged in a vacuum chamber so that the housing is depressurized before the filling opening is closed.

A method for producing a battery cell is known from US Patent Application Publication No. 2012/0040230 A1, wherein the gases contained in an anode chamber of the battery cell are sucked off before the battery cell is closed.

Proceeding from this, it is an object of the invention to at least partially solve the problems described in connection with the prior art. In particular, a method for producing a battery cell is to be specified, in which an opening in the housing provided for filling in an electrolyte can be closed securely and reliably and with which a non-porous welded surface is achieved.

### SUMMARY OF THE INVENTION

These objects are solved by the features of the independent claims. Further advantageous refinements of the solution proposed here are specified in the dependent patent claims. It should be pointed out that the features listed individually in the dependent patent claims can be combined with one another in any technologically reasonable manner and define further refinements of the invention. In addition, the features specified in the patent claims are specified and explained in more detail in the description, wherein further preferred refinements of the invention are presented.

A method for producing a battery cell is proposed. The battery cell has a housing having a first volume and, in the first volume, a multiplicity of electrodes that are stacked on top of one another and optionally additionally wound electrodes and an electrolyte. The electrolyte can be introduced into the first volume via an opening in the housing. The method comprises at least the following steps:
a) Providing the battery cell with housing and electrodes arranged therein and the electrolyte as well as the unsealed opening;
b) Degassing the first volume via the opening and closing the opening with a closing element, wherein the closing element and the opening form a non-material connection;
c) Arranging a chamber on the housing such that the opening and the closing element are arranged within the chamber and at least part of the housing is arranged outside of the chamber;
d) Creating a negative pressure in the chamber;
e) Providing a laser welding device and materially connecting the closing element to the housing by means of a laser beam, so that the opening is sealed in a gas-tight manner by the material connection produced in this way.

The above classification (which is not exhaustive) of the method steps into a) to e) should serve primarily only for differentiation and not to necessitate a sequence and/or dependency. The frequency of the method steps may also vary, for example. It is also possible that method steps overlap one another at least partially in time. Method steps c), d) and e) very particularly preferably take place at least partially in parallel. In particular, step d) is initiated immediately after arranging the chamber on the housing and is also performed during step e). In particular, the negative pressure generated according to step d) is thus maintained during step e). In particular, steps a) to e) are performed in the order listed.

The housing is in particular a dimensionally stable (i.e. only a plastically deformable) housing. The housing is also referred to as a hard case and the battery cell, for example, as a prismatic cell.

The housing can also be designed as a pouch cell. A pouch cell comprises a deformable housing consisting of a pouch film and is therefore not a prismatic cell (having a dimensionally stable housing). A pouch foil is a known deformable housing part that is used as a housing for so-called pouch cells. It is a composite material, for example comprising a plastics material and aluminum.

The electrodes are in particular stacked or stacked and wound in a known manner (jelly roll, etc.) and are acted upon by an electrolyte or an electrolyte liquid.

In particular, the term electrodes includes a multiplicity of electrode foils and separators which are arranged stacked on top of one another or stacked and then wound together. The electrodes can be arranged as a single sheet stack, lamination, Z-fold, jelly roll, each in any number.

The electrodes are, in particular, foil-like, i.e. they have a large side surface and a small thickness. In particular, a coating with active material is arranged on the side surface or on each side surface of the electrode. The separators are each arranged between the side surfaces of the adjacently arranged different electrodes. In particular, uncoated parts of the electrodes extend out of the stack of electrodes as conductors.

In particular, the anodes and the cathodes within the stack of electrodes are connected in parallel with one another, so that the conductors of a plurality of anodes are electrically conductively connected to one another and the conductors of a plurality of cathodes are electrically conductively connected to one another.

The battery cell is in particular a lithium-containing battery cell, in particular a secondary cell, i.e. a rechargeable battery cell.

In the present case, it is proposed in particular to initially seal the opening with a closing element, so that the opening is already closed during the welding process that is subsequently performed. Contamination of the electrolyte can thus be prevented. It is also proposed to perform the laser welding in a vacuum or negative pressure (that is to say in the absence of air). In this way, the process stability of the laser welding can be increased and the quality of the weld seam can be decisively improved. In order to be suitable for mass production, it is proposed to generate the negative pressure in the smallest possible chamber, so that the atmosphere for welding can be created as quickly as possible and with the lowest possible use of energy and auxiliary materials.

According to step a), the fundamentally known battery cell with housing and electrodes arranged therein and the electrolyte as well as the unsealed opening is provided. The opening is arranged in particular in a dimensionally stable part of the housing.

According to step b), the first volume is degassed via the opening in a known manner and the opening is sealed with a closing element, wherein the closing element and the opening form a non-material connection, i.e. a non-positive and/or positive connection.

Positive connections are created by the interlocking of at least two connection partners. As a result, the connection partners cannot become detached even without power transmission or when power transmission is interrupted. In other words, in the case of a positive connection, one connection partner is in the way of the other. For example, the closing element is designed as a rivet, which is inserted into the opening undeformed and then deformed at least within the volume, so that the closing element is arranged captively in the opening. Alternatively, the closing element can be designed with a thread and the opening with a counter-thread, so that at least with respect to one axis a form fit between thread and housing and with respect to a circumferential direction a non-positive connection is realized.

Non-positive connections require a normal force on the surfaces to be connected. Their mutual displacement is prevented as long as the counter-force caused by the static friction is not exceeded. For example, the closing element is arranged in the opening via a press fit or a thread.

All connections in which the connection partners are held together by atomic or molecular forces are called material connections. At the same time, they are non-detachable connections that can only be separated by destroying the connection means. As described below, the closing element is materially connected to the housing using a laser process.

The closing element can be made in one piece or in several pieces. The closing element or parts thereof can be deformed during the arrangement in the opening, so that the required non-positive and/or positive connection is realized.

The closing element and the housing in particular form a contact surface with one another, which is suitably designed by a subsequent laser process to form a material connection.

The material of the closing element substantially corresponds to the material of the housing in this area, at least in the region of the contact surface or in the region of the subsequent material connection.

According to step c), a chamber is arranged on the housing, so that the opening and the closing element are arranged inside the chamber and at least one part of the housing is arranged outside the chamber. The chamber has the function of sealing the closing element and part of the housing from the environment of the battery cell and the chamber, so that a special atmosphere can be set within the chamber, preferably a vacuum or partial vacuum that can be implemented via a vacuum device connected to the chamber.

In particular, the chamber has an open side surface which is arranged on the housing. The chamber thus surrounds a surface of the housing which comprises the opening or the closing element, a heat-affected zone of the weld created in step e) and an additional zone surrounding the weld and the heat-affected zone. The additional zone prevents the chamber from being damaged by contacting the heat-affected zone.

The fixation between the chamber and the surface of the housing can be achieved by a special clamping device or by a suction system, e.g. by a vacuum device connected to the chamber.

The chamber contacts the housing in particular via a contact surface. The material of this bearing surface can be a rubber or a soft metal in order to avoid damaging the housing by arranging the chamber due to the negative pressure conditions in the chamber.

Step d) includes creating a negative pressure, i.e. a partial vacuum or vacuum, in the chamber. For this purpose, in particular, a vacuum device is connected to the chamber, via which air can be sucked out of the chamber.

Step e) comprises the provision of a laser welding device and the material connection of the closing element to the housing by means of a laser beam, so that the opening is gas-tightly closed by the material connection produced in this way.

As a result of the vacuum or partial vacuum inside the chamber, a high-quality weld can be realized.

The laser welding device may include in particular a known infrared source, e.g. an infrared laser.

In particular, the laser beam is coupled into the chamber via a transparent wall of the chamber. In particular, the transparent wall of the chamber is arranged opposite the open side surface of the chamber.

Alternatively, the laser beam can also be introduced into the chamber via a light guide and only emerge from the light guide inside the chamber.

During step e), the chamber is arranged in particular immovably on or in relation to the housing. In particular, the laser beam is moved relative to the housing and relative to an environment to create the weld seam. Alternatively or additionally, the housing having the chamber is moved relative to the laser beam and the environment.

In particular, the chamber has a bearing surface for contacting the housing, wherein the bearing surface is designed to be suitable for gas-tight sealing of the chamber with respect to the environment.

In particular, the chamber has a second volume that is smaller than the first volume. The second volume of the chamber is therefore always smaller than the first volume enclosed by the housing. Thus, the housing cannot be arranged inside the chamber.

In particular, the second volume is at most 5 percent, preferably at most 2 percent, particularly preferably at most 1 percent, of the first volume. The second volume is therefore designed to be as small as possible, so that a negative pressure only has to be generated in a small volume for each welding process. The method can thus be carried out inexpensively.

In particular, the closing element comprises a sealing material, by means of which the opening is closed at least in a liquid-tight manner before step c). The sealing material includes, for example, a deformable material deformed by the closing element during placement of the closing element in the opening to seal the seal. The sealing material arranges itself in particular outside of the weld seam that is produced later.

In particular, before step c), the closing element is connected to the housing at least in a positive manner, if necessary additionally in a force-fitting manner.

In particular, the (negative) pressure in the chamber is less than 30 mbar [millibar], preferably less than 20 mbar.

Due to a low-pressure atmosphere within the chamber, in particular a lower energy density is required to produce the laser weld seam. The special conditions of the atmosphere created in this way lead to an increase in the beam stability of the laser beam; gases and vapors during welding are more easily extracted from the molten material by the vacuum device and sparks and spatter are reduced.

Due to the lower impact of energy on the housing, the possibilities for heating the electrolyte are also reduced in particular, and safety is increased when the electrolyte comes into contact with the laser beam.

The method is carried out, in particular, in an automated production facility and by a control device that is equipped, configured or programmed to carry out the method described.

A production plant is therefore proposed which has at least one handling device for the housing or the battery cell, a laser welding device, a vacuum device and a chamber connected thereto, and the control unit.

Furthermore, the process can also be performed by a computer or with a processor of a control unit. Accordingly, a system for data processing is also proposed which comprises a processor which is adapted/configured in such a way that it performs the method or some of the steps of the proposed method. A computer-readable storage medium can be provided which comprises commands which, when executed by a computer/processor, cause the latter to execute the method or at least some of the steps of the proposed method. The statements relating to the method are transferable, in particular, to the production plant, to the control device and/or the computer-implemented method (that is to say, the computer or the processor, the data processing system, the computer-readable storage medium) and vice versa.

The use of indefinite articles (“a” and “an”), in particular in the claims and the description reproducing them, is to be understood as such and not as a numeral. Correspondingly, the terms or components thus introduced are to be understood in such a way that they are present at least once and, in particular, can also be present several times.

As a precaution, it should be noted that the numerals used here (“first,” “second,” . . . ) serve primarily (only) to differentiate between a plurality of similar objects, sizes or processes, and in particular, therefore, do not necessarily prescribe any dependency and/or sequence of these objects, sizes, or processes relative to one another. Should a dependency and/or sequence be necessary, this is explicitly stated here or it is evident for a person skilled in the art to study the specifically described configuration. If a component can occur more than once (“at least one”), the description of one of these components can apply equally to all or part of the majority of these components, but this is not mandatory.

### BRIEF DESCRIPTION OF THE DRAWINGS

The invention and the technical environment are explained in more detail below with reference to the accompanying figures. It should be pointed out that the invention is not intended to be limited by the embodiments mentioned. In particular, unless explicitly stated otherwise, it is also possible to extract partial aspects of the facts explained in the figures and to combine them with other components and findings from the present description. In particular, it should be pointed out that the figures and in particular the proportions shown are only schematic. In the figures:

FIG. 1: a battery cell in an exploded view, in a perspective view;

FIG. 2: the battery cell according to FIG. 1 according to step a), in a perspective view;

FIG. 3: the battery cell according to FIGS. 1 and 2 according to step b), in a perspective view;

FIG. 4: the battery cell according to FIG. 3 with an alternative closing element, in a perspective view;

FIG. 5: the battery cell according to FIGS. 1 to 4 according to step c), in a perspective view;

FIG. 6: the battery cell according to FIGS. 1 to 5 according to step d), in a perspective view;

FIG. 7: the battery cell according to FIGS. 1 to 6 according to step e), in a perspective view; and

FIG. 8: the battery cell according to FIGS. 1 to 7 according to step f), in a perspective view.

### DETAILED DESCRIPTION OF THE INVENTION

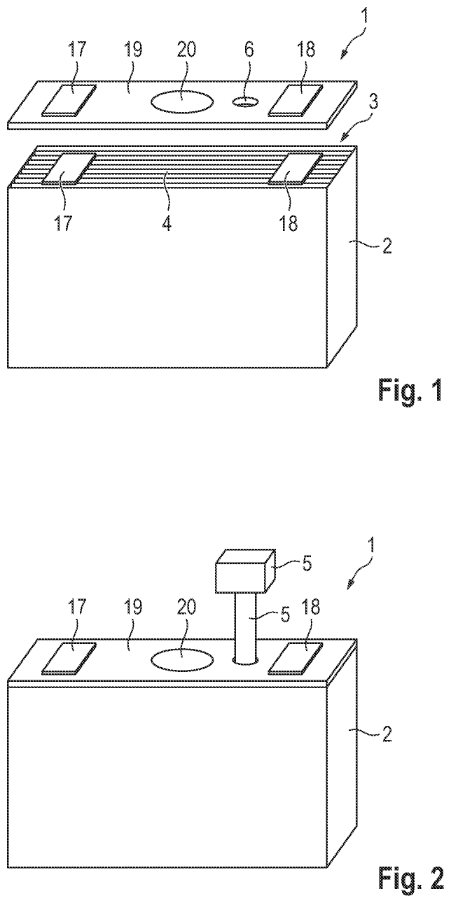

FIG. 1 shows a battery cell 1 in an exploded view, in a perspective view. FIG. 2 shows the battery cell 1 according to FIG. 1 according to step a), in a perspective view. FIGS. 1 to 2 are described together below.

The battery cell 1 has a housing 2 having a first volume 3 and in the first volume 3 a multiplicity of electrodes 4 stacked on top of one another and an electrolyte 5. The electrolyte 5 may be introduced into the first volume 3 via an opening 6 in the housing 2. The housing 2 is a dimensionally stable (i.e. only a plastically deformable) housing 2. The electrodes 4 are in particular stacked in a known manner and are acted upon by an electrolyte 5 or an electrolytic liquid.

The electrodes 4 are foil-like, i.e. they have a large side surface and a small thickness. The separators are each arranged between the side surfaces of the adjacently arranged different electrode foils. The anodes and the cathodes within the stack of electrodes 4 are connected in parallel with one another, so that the conductors of a plurality of anodes are electrically conductively connected to one another and the conductors of a plurality of cathodes are electrically conductively connected to one another. The conductors of the anodes are electrically conductively connected to a first connection 17 and the conductors of the cathodes are electrically conductively connected to a second connection 18.

The rigid housing 2 has a cover 19 on which the first connection 17 and the second connection 18 for the electrical connection of the electrodes 4 arranged inside the housing 2 to a circuit arranged outside the housing 2, as well as the closable opening 6 for filling the first volume 3 are provided with the electrolyte 5. Furthermore, a pressure relief valve 20 is arranged in the cover 19, via which pressure relief to an environment 13 can take place when the pressure in the first volume 3 increases.

According to step a), the battery cell 1 is provided with the housing 2 and electrodes 4 arranged therein and the electrolyte 5 as well as the unsealed opening 6. The opening 6 is arranged in a dimensionally stable part of the housing 2, the cover 19.

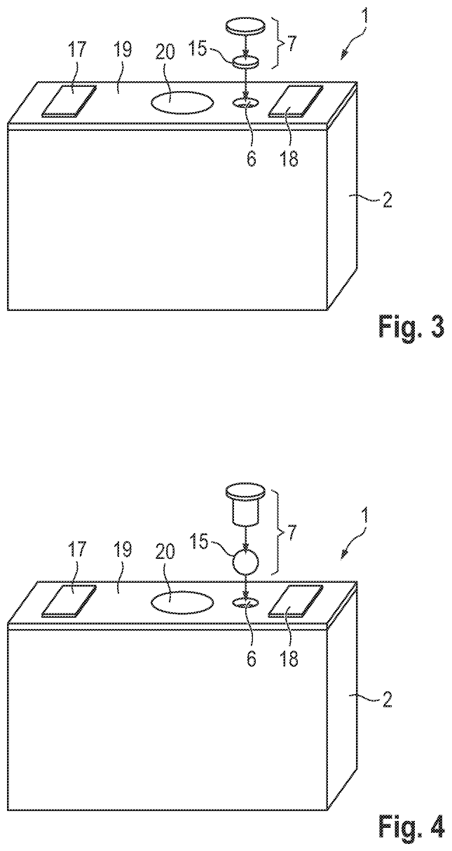

FIG. 3 shows the battery cell 1 according to FIGS. 1 and 2 according to step b), in a perspective view. FIG. 4 shows the battery cell 1 according to FIG. 3 with an alternative closing element 7 in a perspective view. FIGS. 3 to 4 are described together below. Reference is made to the statements about FIGS. 1 to 2.

According to step b), the first volume 3 is degassed via the opening 6 in a known manner and the opening 6 is sealed with a closing element 7, wherein the closing element 7 and the opening 6 have a non-material connection, i.e. a non-positive and/or positive connection.

In both cases of FIGS. 3 and 4, the closing element 7 is designed in two parts. In doing so, for example, the one element, for example a sealing material 15, are deformed by the other element of the multi-part closing element 7 so that a good seal of the opening 6 can be achieved. In FIG. 3 the closing element 7 comprises two discs. In FIG. 4, the locking element 7 comprises a bolt and a ball which can be deformed by the bolt.

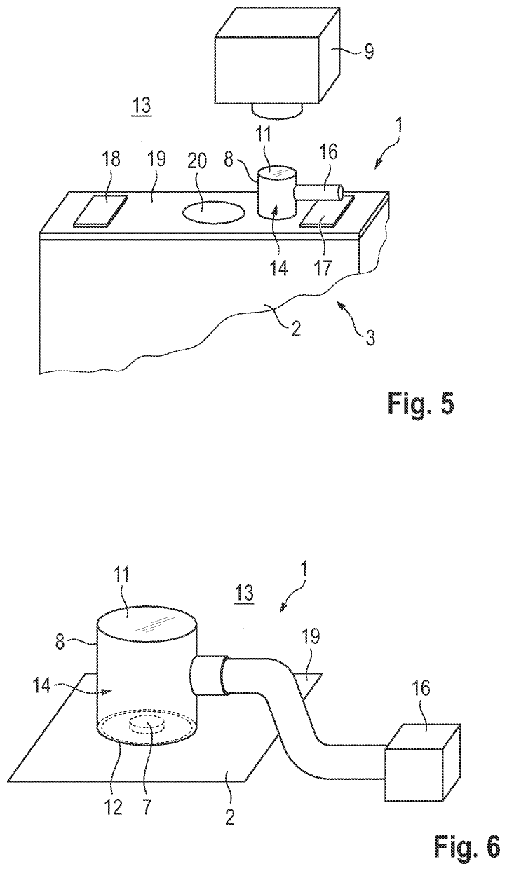

FIG. 5 shows the battery cell 1 according to FIGS. 1 to 4 according to step c), in a perspective view. FIG. 6 shows the battery cell 1 according to FIGS. 1 to 5 according to step d), in a perspective view. FIGS. 5 to 6 are described together below. Reference is made to the statements relating to FIGS. 1 to 4.

According to step c), a chamber 8 is arranged on the housing 2 so that the opening 6 and the closing element 7 are arranged inside the chamber 8 (see also FIG. 6) and at least a part of the housing 2 is arranged outside the chamber 8. The chamber 8 has the function of sealing the closing element 7 and a part of the housing 2 from an environment 13 of the battery cell 1 and the chamber 8, so that a special atmosphere can be set within the chamber 8, preferably a vacuum or partial vacuum that has a vacuum device 16 connected to the chamber 8 can be realized. The chamber 8 has a second volume 14 that is significantly smaller than the first volume 3.

The chamber 8 has an open side which is placed on the housing 2. The chamber 8 thus surrounds a surface of the housing 2 which comprises the opening 6 or the closing element 7, a heat-affected zone of the weld seam 21 produced in step e) and an additional zone surrounding the weld seam 21 and the heat-affected zone. The additional zone prevents the chamber 8 from being damaged by contacting the heat-affected zone.

The fixation between the chamber 8 and the surface of the housing 2 is effected by a suction system or by a vacuum device 16 connected to the chamber 8. The chamber 8 contacts the housing 2 via a bearing surface 12. The material of this bearing surface 12 can be a rubber or a soft metal in order to avoid damaging the housing 2 by arranging the chamber 2 due to the negative pressure conditions in the chamber 8.

Step d) comprises creating a negative pressure, i.e. a partial vacuum or a vacuum, in the chamber 8. For this purpose, the vacuum device 16 is connected to the chamber 8 via which air can be sucked out of the chamber 8.

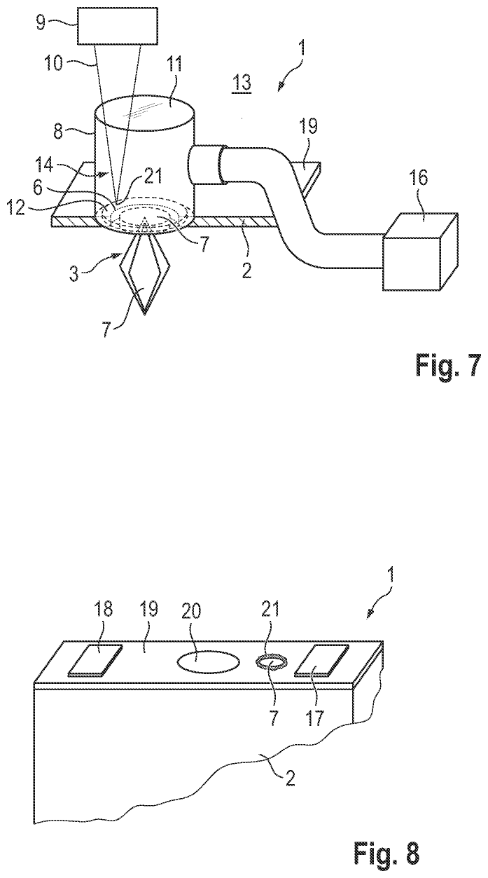

FIG. 7 shows the battery cell 1 according to FIGS. 1 to 6 according to step e), in a perspective view. Reference is made to the statements on FIGS. 1 to 6.

Step e) comprises the provision of a laser welding device 9 and the material connection of the closing element 7 to the housing 2 by a laser beam 10, so that the opening 6 is gas-tightly sealed by the material connection or weld seam 21 thus produced.

The laser beam 10 is coupled into the chamber 8 via a transparent wall 11 of the chamber 8. The transparent wall 11 of the chamber 8 faces the open side surface of the chamber 8 and the housing 2.

The chamber 8 is arranged immovably on or in relation to the housing 2 during step e). The housing 2 is moved with the chamber 8 relative to the laser beam 10 and the environment 13.

In FIG. 7 it can be seen that the closing element 7 is designed as a rivet that is introduced undeformed into the opening 6 and then deformed at least within the first volume 3 so that the closing element 7 is arranged captively in the opening 6.

FIG. 8 shows the battery cell 1 according to FIGS. 1 to 7 according to step f), in a perspective view. Reference is made to the statements about FIGS. 1 to 7.

The battery cell 1 is now ready for operation. The opening 6 is sealed by the closing element 7 and the closing element 7 is materially connected to the housing via the weld seam 21.

### LIST OF REFERENCE SIGNS

1 Battery cell
2 Housing
3 First volume
4 Electrode
5 Electrolyte
6 Opening
7 Closing element
8 Chamber
9 Laser welding device
10 Laser beam
11 Wall
12 Bearing surface
13 Environment
14 Second volume
15 Sealing material
16 Vacuum device
17 First connector
18 Second connector
19 Cover
20 Pressure relief valve
21 Weld seam

1. A method for producing a battery cell, comprising:
a) providing a housing having a first volume, and, in the first volume, a multiplicity of electrodes stacked one on top of another and an electrolyte, wherein the electrolyte is introduced into the first volume via an unsealed opening;
b) degassing the first volume via the opening and closing the opening with a closing element, wherein the closing element and the opening form a non-material connection;
c) arranging a chamber on the housing so that the opening and the closing element are arranged inside the chamber and so that at least one part of the housing is arranged outside the chamber;
d) creating a negative pressure in the chamber; and
e) providing a laser welding device and materially connecting the closing element to the housing using a laser beam, so that the opening is sealed gas-tight by the material connection thus created.

2. The method according to claim 1, in which the laser beam is coupled into the chamber via a transparent wall of the chamber.

3. The method according to claim 1,
wherein the chamber has a bearing surface for contacting the housing, and
wherein the bearing surface is designed to seal the chamber gas-tight from an environment.

4. The method according to claim 1, wherein the chamber has a second volume which is smaller than the first volume.

5. The method according to claim 4, wherein the second volume is at most 5 percent of the first volume.

6. The method according to claim 1, wherein the closing element comprises a sealing material by which the opening is closed in a liquid-tight manner before step c).

7. The method according to claim 1, wherein the closing element is connected to the housing in a form-fitting manner before step c).

8. The method according to claim 1, wherein the negative pressure in the chamber is less than 30 mbar.
